(19) United States
(12) Patent Application Publication
(10) Pub. No.: US 2010/0112254 A1
(43) Pub. Date: May 6, 2010

(54) COLOURED PLAYING BOWL

(75) Inventor: Giancarlo Data, Pinasca (IT)

Correspondence Address: MAIER & MAIER, PLLC, 1000 DUKE STREET, ALEXANDRIA, VA, 22314, US

(73) Assignee: DATA F. S.R.L., Pinasca (IT)

(21) Appl. No.: 12/529,275

(22) PCT Filed: Mar. 13, 2007
(86) PCT No.: PCT/IT2007/000207

§ 371 Date: Aug. 31, 2009

(51) Int. Cl. A63B 37/00; B32B 1/00; B32B 15/08; B32B 25/08; A63B 45/02

(52) U.S. Cl. 428/35.8; 428/36.8; 428/35.7

(57) ABSTRACT

A game bowl is disclosed, comprising an internal core covered with an external shell made of plastic material.

### RELATED APPLICATIONS

The present invention is a national stage application which claims priority to international patent Application No. PCT/IT2007/000207, filed on Mar. 21, 2007, the disclosure of which is incorporated by reference herein in its entirety.

### BACKGROUND OF THE INVENTION

1. Field of the Invention

The present invention refers to a colored playing bowl.

2. Background Art

As known, the game of bowls consists in the attempts by players to approach as much as possible their own bowls to an objective, called jack. Each competitor attempts, in turn to take his own bowls still nearer to this jack or to remove those bowls that prevent it. Depending on the mode with which bowls can be launched towards the jack, the game of bowls is divided into various categories, the most known and played of which are the game of “Raffa”, the game of “Volo” and the game of “Petanque”.

The game of Raffa consists in approaching as much as possible one's own bowls to the jack (objective) with the technique of “gone and point” and in removing the opponent's bowls, or in striking the jack, by launching onw's own bowls with the “raffata” (grazing throw) technique or the “volo” (parabola-type throw with fall within a delimited space) technique. In this case, the bowls are traditionally shaped as a ball with a diameter included between 10.4 cm and 11.1 cm, of a synthetic material, with a weight included between 860 g and 980 g.

The principle of the game of Volo is almost equal to the Raffa specialty excluding the “raffata” throw. The bowls are shaped as a ball, made of metal, with a diameter included between 9 cm and 10.2 cm and a weight included between 900 g and 1200 g.

The game of Petanque is the version with “unmoving feet” of the game of Volo, in which players are divided into “approachers” (whose objective is launching the bowl as near as possible to the jack by overcoming the obstacles that occurs on the ground) and into “bowl-launchers” (whose objective is trying and remove, with a flying stroke, the opponent's bowl).

In the various game categories described above, traditionally, the bowls of various players are mutually identified and divided by means of surface grooves, whose arrangement and number allow identifying the bowls of each player from the bowls of other players. In order to improve the bowls identification, it has also been thought, in addition to engrave references, to engrave the player's initials or name on the external surface of the bowl, or even to partially or totally modify the appearance or coloring of the bowl by means of an appropriate treatment applied to the bowl as a whole, or locally, by providing for depositing a coating or elements with different colors or appearances from the rest of the bowl, into the grooves or other recesses. In particular, French patent No. FR2633525 in the name of Obut Boule, discloses a metal bowl for the game of Petanque in which the bowl identification occurs by means of colored elastic rings arranged inside circular grooves obtained on the external surface of the bowl itself.

The above proposed solutions, however, have inconveniences. In practice, in fact, it has been observed that, due to the wear consequent to the bowl rolling on the ground and the impacts against other bowls (extremely high above all in the Volo game category), the surface-applied colors or the appearance changes of the various known shapes, get ruined in time, making more and more difficult to easily and quickly identify the bowls of every player. Moreover, the known grooves and the methods that provide for coloring or applying coloring elements inside them (like in the above described French patent), though allowing to identify bowls for players in the field, are scarcely visible, if not even unrecognisable, outside the field, for example by possible viewers, in stands or on television, that therefore have difficulties in following the game easily and with the due timing, consequently impairing the mediatic impact of this sports discipline.

### SUMMARY OF THE INVENTION

Therefore, object of the present invention is solving the above prior art problems, by providing a colored playing bowl that allows immediately identifying the bowls of each player involved in the game.

Another object of the present invention is providing a colored playing bowl that is extremely resistant to wear and bumps, even in case of the Volo game category.

The above and other objects and advantages of the invention, as will result from the following description are obtained with a colored playing bowl as described in claim 1. Preferred embodiments and non-trivial variations of the invention are the subject matter of the dependent claims.

### BRIEF DESCRIPTION OF THE DRAWINGS

The present invention will be better described by some preferred embodiments thereof, provided as a non-limiting example, with reference to the enclosed drawings, in which:

FIG. 1a shows a sectional view of a preferred embodiment of the colored playing bowl according to the present invention;

FIG. 1b shows a middle sectional view of another preferred embodiment of the colored playing bowl according to the present invention;

FIG. 2a shows a middle sectional view of another preferred embodiment of the colored playing bowl according to the present invention;

FIG. 2b shows a magnification of the parts contained in box A in FIG. 2a;

FIG. 3a shows another middle sectional view of another preferred embodiment of the colored playing bowl according to the present invention; and

FIG. 3b shows a middle sectional view of another preferred embodiment of the colored playing bowl according to the present invention.

### DETAILED DESCRIPTION OF A PREFERRED EMBODIMENT

With reference to the Figures, it is possible to note that the game bowl 1 according to the present invention comprises an internal core 3, preferably and substantially shaped as a ball, covered with an external shell 5 made of plastic material, such external shell 5 having a substantially spherical external surface and an internal surface complementary to the shape of the internal core 3.

In particular, the internal core 3 is preferably made of metal or a metallic alloy with a homogeneous chemical composition; still more preferably, the internal core 3 is made of steel or aluminium.

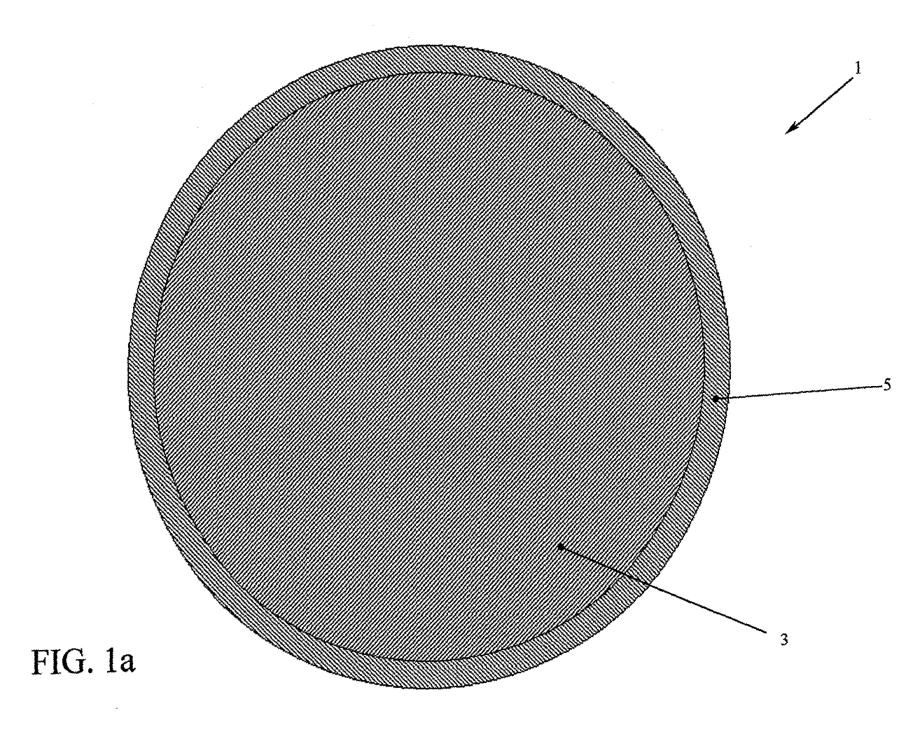

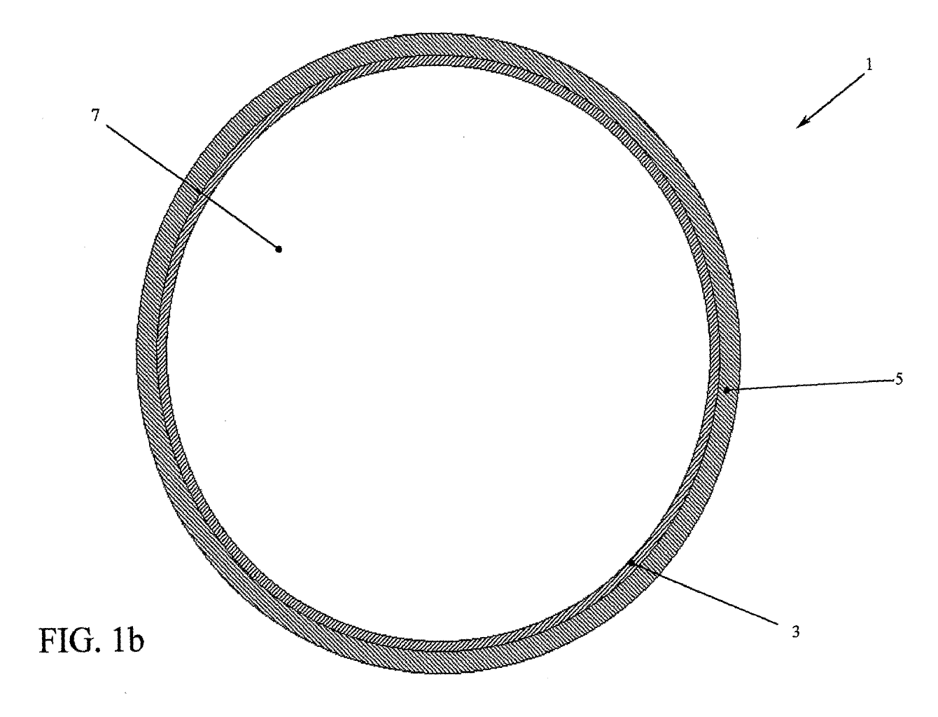

Obviously, for example as shown in FIG. 1a, the internal core 3 can be filled-up; in such case, the internal core 3 can also be made of rubber.

In an alternative variation, for example as the one shown in FIG. 1b, the internal core 3 can be internally equipped with at least one recess 7, and such recess 7 can be empty or filled-up. In this latter case, filling-up is preferably made with an inert material or with a homogeneous mixture of many inert materials, such as for example brass powder. The possible filling must be statically balanced and preserve such balancing during and after the use of the game bowl 1.

In a preferred embodiment of the game bowl 1 according to the present invention, the external shell 5 is made of a colored plastic material (preferably of a blue or red color). In an alternative embodiment of the game bowl 1 according to the present invention, the external shell 5 is made of transparent plastic material and the external surface of the internal core 3 is colored (preferably with a blue or red color).

The plastic material can obviously be of any type, and in particular can be any polymer having mechanical and physical characteristics that are able to confer to the external shell 5 an adequate resistance to wear and bumps deriving from the use of the game bowl 1 according to the present invention. In particular, the Applicant has detected that currently the plastic material having those mechanical and physical characteristics that are most complying with the specific needs of the present field of application is thermoplastic polymer of an amorphous type, commercially identified with trade name LEXAN® and used within the present invention either in its transparent form (if it is provided to color the internal core 3) or after having added the desired colored pigment. LEXAN® in fact is a polycarbonate provided with high-level properties, such as high impact resistance, high transparency, strong consistency and durability characteristics, high thermal resistance, high dimensional stability, unlimited coloring possibilities, UV stability and optimum workability. In particular, the mechanical workability of LEXAN® is such that plates are cold bent and curved. Moreover, LEXAN® is also easily thermoformable and this allows creating even very complex three-dimensional pieces.

Alternatively, the Applicant has detected that the external shell 5 could also be made of the plastic material commercially identified with trade name DELRIN® (in particular, DELRIN® 100) manufactured by company DuPont of Nemours (France): DELRIN® is a family of acetal resins known for their dimensional stability, stiffness, fatigue and corrosion resistance and characterised by a very low wear coefficient.

It is anyway wholly obvious that the use of any other plastic material, such as for example nylon, for manufacturing the external shell 5 and different from the ones mentioned above merely as an example, falls within the scope of the present invention.

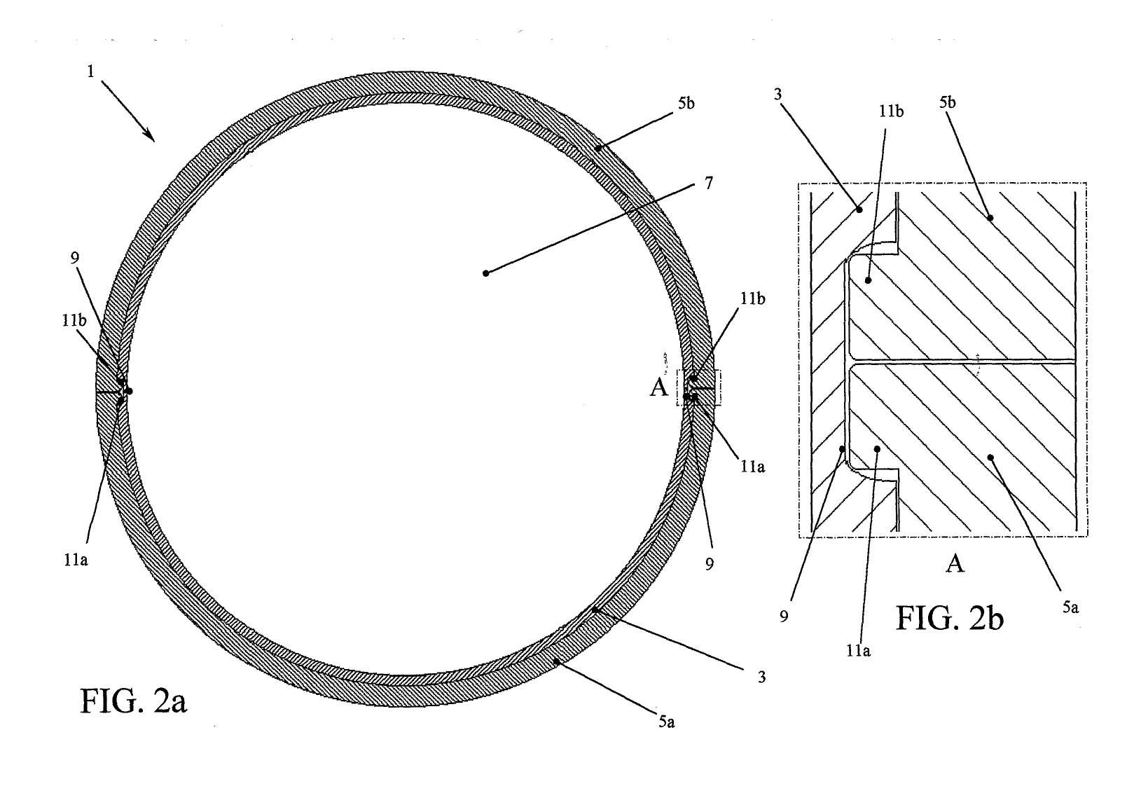

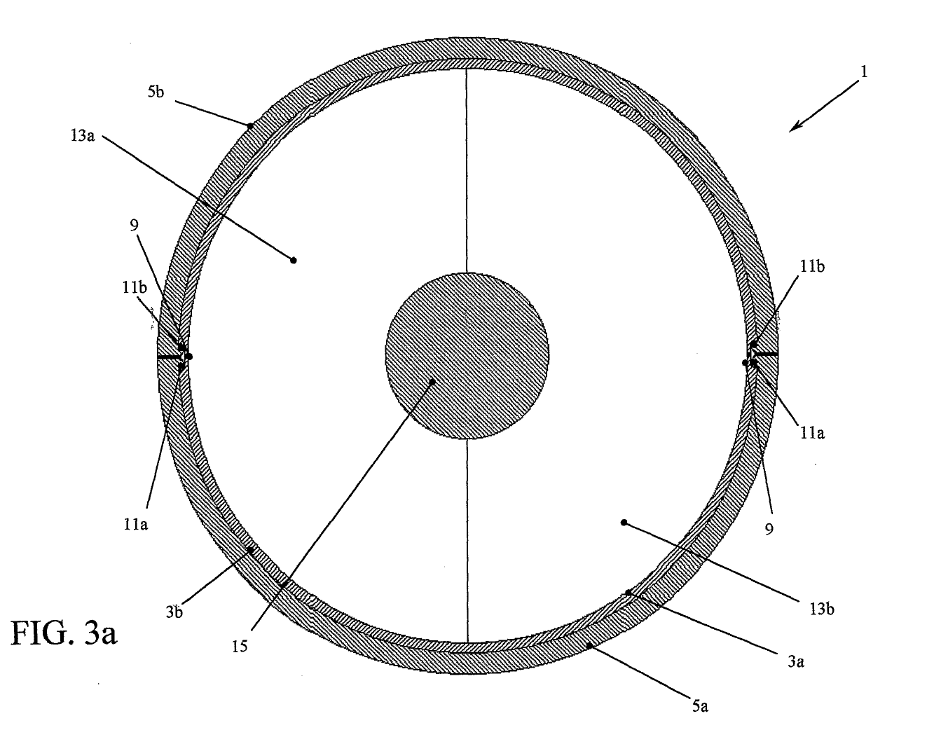

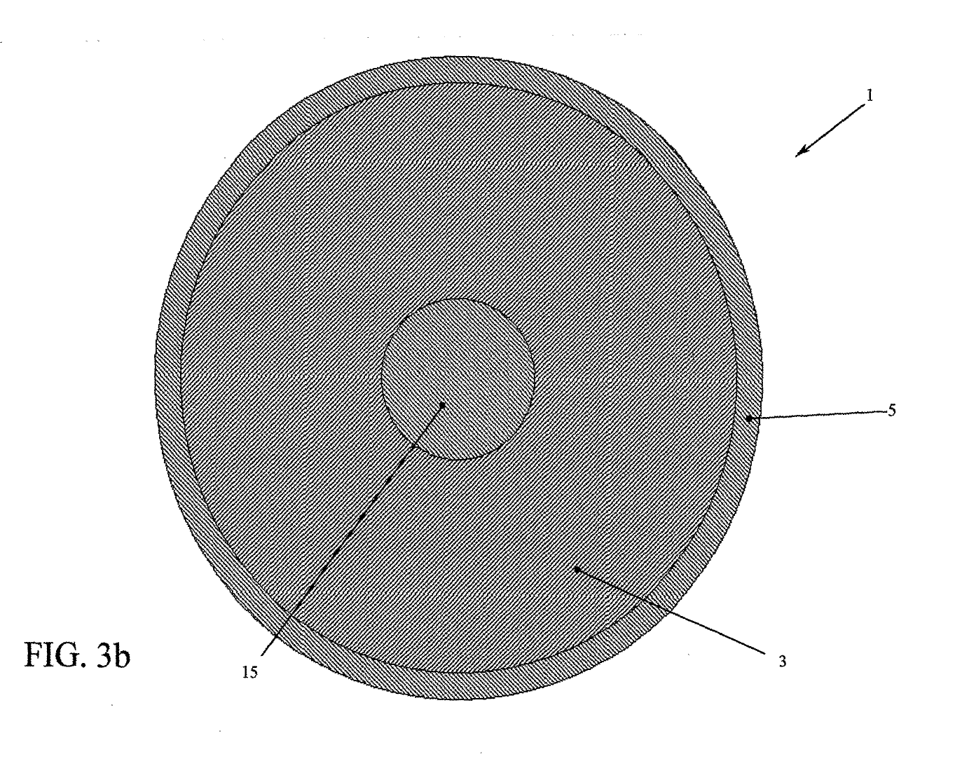

It is clear for any skilled person in the field that the external shell 5 can be applied on the internal core 3 in different ways; for example, the external shell 5 can be molded by injection of its plastic material directly as coverage of the internal core 3 and therefore cover it seamlessly; alternatively, the external shell 5 can be composed of many, mutually complementary parts in order to fully cover the internal core 3. In the preferred embodiment of the game bowl 1 according to the present invention shown in FIGS. 2a and 3a, it is possible to note that the external shell 5 is composed of two half-shells 5a, 5b, each one of which is of a hollow semispherical shape, to be applied above the internal core 3 through fastening means. Though such fastening means can provide even only for the simple gluing or welding of the half-shells 5a and 5b above the internal core 3, in order to make integration between internal core 3 and external shell 5 more stable, and assembling of the game bowl 1 according to the present invention easier and quicker, the fastening means comprise at least one surface groove 9 of the internal core 3, such surface groove 9 being preferably circular and placed next to a maximum circle of the internal core 3, inside which respective fastening teeth 11a, 11b, with which the perimetral edges of each half-shell 5a, 5b are equipped, are engaged and meshed due to elastic distortion.

In another preferred and alternative embodiment of the game bowl 1 according to the present invention, as the one shown in particular in FIG. 3a, the recess 7 of the internal core 3 contains inside it a rubber filling, preferably made as two semispheres 13a, 13b, equipped, in a concentric position with the internal core 3 and the external shell 5, with a containing seat of at least one metallic mass 15, perferably with a spherical shape, due to obvious balancing issues; such metallic mass 15 advantageously avoids, above all in the Volo game category, that the game bowl 1 according to the invention is subjected to an excessive rebound on the game field.

In another alternative embodiment, for example as the one shown in FIG. 3b, the internal core 3 is made of rubber and inside it contains, in a substantially central position, the metallic mass 15, preferably of a spherical shape, whose functions are analogous to the previously described ones.

It is clear that, preferably, the game bowl 1 as a whole has weights and sizes complying with what is required by regulations of sports Federations that are responsible for creating standards for the game of bowls in its various categories. Preferably, therefore, as required for example by regulations of the Federazione Italiana Bocce (F.I.B.) (Italian Bowls Federation), the game bowl 1 according to the present invention will have to:
be spherical, with a tolerance of 2/10 of a mm;
be balanced, with a tolerance not greater than 1.1 of the bowl mass;
have an external diameter from 90 mm to 110 mm (minimum diameter of 88 mm for boys under 14 years of age and women);
have a global mass from 900 g to 1200 g (minimum mass of 800 g for boys under 14 years of age and women).

What is claimed is:

1. A game bowl comprising:
an internal core covered with an external shell made of plastic material, wherein the internal core has a spherical shape, the external shell has a substantially spherical external surface and an internal surface complementary to the spherical shape of the internal core, and the internal core is made either of metal, or of a metallic alloy, or of rubber, or of steel, or of aluminium.

2. The game bowl of claim 1, wherein the internal core is internally equipped with at least one recess.

3. The game bowl of claim 2, wherein the recess is empty.

4. The game bowl of claim 2, wherein the recess is filled-up.

5. The game bowl of claim 4, wherein the recess is filled-up with an inert material.

6. The game bowl of claim 5, wherein the inert material is brass powder.

7. The game bowl of claim 1, wherein, when the internal core is made of rubber, the internal core is internally equipped in a central position of the internal core with at least one metallic balancing mass.

8. The game bowl of claim 4, wherein the recess is filled-up with a rubber filling equipped, in a concentric position with the internal core and the external shell, with a seat adapted to contain at least one metallic balancing mass.

9. The game bowl of claim 8, wherein the rubber filling is composed of two semispheres.

10. The game bowl of claim 8, wherein the metallic mass has a spherical shape.

11. The game bowl of claim 1, wherein the plastic material is a thermoplastic techno-polymer of an amorphous type.

12. The game bowl of claim 1, wherein the plastic material is transparent.

13. The game bowl of claim 12, wherein an external surface of the internal core is colored.

14. The game bowl of claim 1, wherein the plastic material is colored.

15. The game bowl of claim 1, wherein the external shell is composed of many mutually complementary parts in order to completely cover the internal core.

16. The game bowl of claim 1, wherein the external shell is composed of two half-shells.

17. The game bowl of claim 16, wherein the half-shells are fixed over the internal core through fastening means.

18. The game bowl of claim 17, wherein the fastening means are gluing or welding.

19. The game bowl of claim 17, wherein the fastening means comprise at least one surface groove of the internal core, inside which respective fastening teeth, with which perimetral edges of each one of the half-shells are equipped, are engaged and meshed by elastic distortion.

20. The game bowl of claim 19, wherein the surface groove is circular and is placed next to a maximum circle of the internal core.
